(19) United States
(12) Patent Application Publication
(10) Pub. No.: US 2015/0197425 A1
(43) Pub. Date: Jul. 16, 2015

(54) CARBON DIOXIDE RECOVERY METHOD AND CARBON DIOXIDE RECOVERY DEVICE

(71) Applicant: NIPPON STEEL & SUMIKIN ENGINEERING CO., LTD., Tokyo (JP)

(72) Inventors: Mikihiro Hayashi, Tokyo (JP); Yutaka Ekuni, Tokyo (JP); Tomohiro Mimura, Tokyo (JP)

(73) Assignee: NIPPON STEEL & SUMIKIN ENGINEERING CO., LTD., Tokyo (JP)

(21) Appl. No.: 14/416,216

(22) PCT Filed: Jul. 26, 2013
(86) PCT No.: PCT/JP2013/070382

§ 371 Date: Jan. 21, 2015

(30) Foreign Application Priority Data
Jul. 26, 2012 (JP) 2012-166271

(51) Int. Cl. C01B 31/20; B01D 53/62; B01D 53/78

(52) U.S. Cl. CPC C01B 31/20; B01D 53/78; B01D 53/62; B01D 2252/504; B01D 2257/504

(57) ABSTRACT

A carbon dioxide recovery method according to the present application includes a carbon dioxide absorption step of bringing an absorbing solution into contact with a gas to be treated including carbon dioxide to absorb the carbon dioxide in the gas to be treated, and a carbon dioxide separation step of heating the absorbing solution in which the carbon dioxide is absorbed to separate the carbon dioxide from the absorbing solution, wherein an aqueous amine solution having properties that a rate of change in an absorbed amount of carbon dioxide relative to a temperature change gradually decreases as the temperature increases in a heating temperature range in the carbon dioxide separation step is used as the absorbing solution, and the heating temperature of the absorbing solution in the carbon dioxide separation step is set to 87° C. to 100° C.

### TECHNICAL FIELD

The present invention relates to a carbon dioxide recovery method and a carbon dioxide recovery device.

Priority is claimed on Japanese Patent Application No. 2012-166271, filed Jul. 26, 2012, the content of which is incorporated herein by reference.

### BACKGROUND ART

As one method of recovering carbon dioxide from gases such as blast furnace gas, boiler exhaust gas, natural gas, and petroleum cracked gas, a chemical absorption method is known. The chemical absorption method is a carbon dioxide recovery method including absorbing carbon dioxide by a chemical reaction using an alkaline solution, in which the carbon dioxide can be selectively dissolved, as an absorbing solution, heating and regenerating the absorbing solution, and releasing the carbon dioxide. As the alkaline solution, for example, an aqueous amine solution and aqueous potassium carbonate solution are used.

In the related art, for example, when carbon dioxide is recovered by a chemical absorption method using an aqueous amine solution, as described in the following PTL 1, the temperature of the aqueous amine solution is increased to 30° C. to 70° C. to absorb carbon dioxide, and the aqueous amine solution in which the carbon dioxide is absorbed is heated to 80° C. to 130° C. to release the carbon dioxide.

In order to effectively operate a carbon dioxide recovery device, it is necessary to increase a recovered amount of carbon dioxide from a gas to be treated as much as possible and reduce a thermal energy requirement (that is, thermal energy consumption volume). Therefore, in order to actually operate the carbon dioxide recovery device, generally, the temperature of the aqueous amine solution at the time of carbon dioxide recovery is set to 30° C. to 50° C. and the temperature of the aqueous amine solution at the time of carbon dioxide separation is set to substantially 120° C.

### CITATION LIST

### Patent Literature

[PTL 1] Japanese Unexamined Patent Application, First Publication No. H6-91135

### SUMMARY OF INVENTION

### Technical Problem

As effective means to reduce the thermal energy requirement in the carbon dioxide recovery method, a method of suppressing heat radiation loss from the periphery of a regeneration tower by lowering the temperature at the time of carbon dioxide separation, that is, at the time of regeneration can be used. However, when the temperature of the absorbing solution is lowered at the time of regeneration, a remaining amount of carbon dioxide in a lean absorbing solution (absorbing solution after regeneration) is increased and an absorbed amount of carbon dioxide in an absorption tower in the subsequent step is decreased. Therefore, a problem of a recovery rate of carbon dioxide in the gas to be treated being decreased arises.

That is, in the related art, there has been difficulty in reducing a thermal energy requirement while a high carbon dioxide recovery rate is maintained.

As a result of intensive investigation conducted by the present inventors, it has been found that a specific aqueous amine solution has unique properties, that is, properties that a rate of change in an absorbed amount of carbon dioxide relative to a temperature change gradually decreases as the temperature increases in a heating temperature range (absorbing solution regeneration range) of 70° C. or higher in a carbon dioxide separation step. That is, it has been found that as in a graph in which a vertical axis represents an absorbed amount of carbon dioxide and a horizontal axis represents a temperature of the absorbing solution as shown in FIG. 1, a specific aqueous amine solution has properties exhibiting a downward convex curve in a heating temperature range of 70° C. or higher in a carbon dioxide separation step.

The present invention has been made in relation with findings of the properties of the aqueous amine solution as described above, and an object thereof is to provide a carbon dioxide recovery method capable of reducing a thermal energy requirement while maintaining a high carbon dioxide recovery rate.

### Solution to Problem

In order to solve the above-described problem, the present invention proposes the following means.

(1) According to an aspect of the present invention, a carbon dioxide recovery method includes a carbon dioxide absorption step of bringing an absorbing solution into contact with a gas to be treated including carbon dioxide to absorb the carbon dioxide in the gas to be treated, and a carbon dioxide separation step of separating the carbon dioxide from the absorbing solution with heating of the absorbing solution in which the carbon dioxide is absorbed, wherein an aqueous amine solution having properties that a rate of change in an absorbed amount of carbon dioxide relative to a temperature change gradually decreases as the temperature increases in a heating temperature range in the carbon dioxide separation step is used as the absorbing solution, and the heating temperature of the absorbing solution in the carbon dioxide separation step is within a range of 87° C. to 100° C.

In the related art, in a case of an aqueous amine solution (primary aqueous amine solution or secondary aqueous amine solution) that is generally used as a carbon dioxide absorbing solution to recover carbon dioxide from a raw material gas at ordinary pressure, when the heating temperature of the absorbing solution in the carbon dioxide separation step is set to 87° C. to 100° C., a carbon dioxide recovery rate is significantly lowered to substantially 50% to 70% compared to a case in which the heating temperature is set to 120° C. Further, according to the influence above, the thermal energy requirement is also reduced. This is because in the case of the aqueous amine solution that is generally used in the related art, as described above, when the regeneration temperature of the absorbing solution is significantly lowered from 120° C. (for example, lowered to 100° C. or lower), the remaining amount of carbon dioxide in the absorbing solution after regeneration is increased and as a result, the absorbed amount of carbon dioxide in the following carbon dioxide absorption step is decreased.

However, in the present invention, as described above, the aqueous amine solution having properties that the rate of change in the absorbed amount of carbon dioxide relative to the temperature change gradually decreases as the temperature increases in the heating temperature range in the carbon dioxide separation step is used. In this case, even when the regeneration temperature of the absorbing solution is changed from, for example, 120° C. to 100° C., the remaining amount of carbon dioxide in a lean absorbing solution (absorbing solution after regeneration) is not increased much and a relatively small remaining amount of carbon dioxide is maintained. Therefore, when the carbon dioxide is absorbed in the carbon dioxide absorption step, which is the subsequent step, in the absorption tower using such a lean absorbing solution having a low regeneration temperature, the absorbed amount of carbon dioxide is not decreased much and a relatively large amount of absorbed carbon dioxide can be secured.

As a result, compared to a carbon dioxide recovery method of the related art, the thermal energy requirement can be reduced while a carbon dioxide recovery rate of 90% or more is maintained.

In addition, as a heating source in the carbon dioxide separation step, since the heating temperature of the aqueous amine solution at the time of carbon dioxide separation in the related art is substantially 120° C., in a case of using water vapor as a heating source for the aqueous amine solution in the same step, it is necessary to use water vapor of substantially 140° C.

However, in the present invention, since the heating temperature of the aqueous amine solution at the time of carbon dioxide separation is 87° C. to 100° C., as the heating source, for example, low temperature water vapor of substantially 110° C. which is not very useful and typically disposed of (water vapor discharged from other processes after use) can be utilized and thus an operation cost can be significantly lowered.

(2) In the carbon dioxide recovery method according to (1), it is preferable that the heating temperature of the absorbing solution in the carbon dioxide separation step be within a range of 90° C. to 97° C.

When carbon dioxide is recovered within such a temperature range, compared to the carbon dioxide recovery method of the related art, the thermal energy requirement can be reduced while a carbon dioxide recovery rate of 90% or more is maintained.

(3) In the carbon dioxide recovery method according to (1) or (2), it is preferable that the carbon dioxide separation step be carried out under a condition of a gauge pressure of 0.02 MPaG to 0.13 MPaG.

When carbon dioxide is recovered within such a pressure range, the thermal energy requirement can be significantly reduced while a carbon dioxide recovery rate of 90% or more is maintained.

When the gauge pressure is lower than 0.02 MPaG, carbon dioxide and moisture cannot be separately discharged from a condenser attached to an outlet of a regeneration tower where the carbon dioxide separation step is carried out and as a result, the carbon dioxide is not recovered. That is, in order for the gas in the regeneration tower to pass through the condenser attached to the outlet of the regeneration tower, a pressure of substantially 0.02 MPa for a pressure loss is required. On the other hand, when the heating temperature of the aqueous amine solution at the time of carbon dioxide separation is 87° C. to 100° C., the gauge pressure rarely exceeds 0.13 MPaG in a normal operation. That is, the fact that the gauge pressure is 0.13 MPaG means that the pressure inside the regeneration tower reaches an upper limit.

(4) In the carbon dioxide recovery method according to any one of (1) to (3), it is preferable that the aqueous amine solution have a ratio Xa/Xb being 0.77 or more, the ratio Xa/Xb being a ratio of a difference Xa in the absorbed amount of carbon dioxide when the temperature of the aqueous amine solution is changed from 40° C. to 95° C. to a difference Xb in the absorbed amount of carbon dioxide when the temperature of the aqueous amine solution is changed from 40° C. to 120° C., under a condition of a carbon dioxide partial pressure of 60 kPa to 80 kPa.

A high ratio Xa/Xb means that even when the temperature of the absorbing solution in the carbon dioxide absorption step is changed from 120° C. to 95° C., the remaining amount of carbon dioxide in a lean absorbing solution (absorbing solution after regeneration) is not increased much and a relatively small remaining amount of carbon dioxide is maintained. Therefore, since the aqueous amine solution used in the carbon dioxide absorption method of the present invention has a ratio Xa/Xb being 0.77 or more, the thermal energy requirement can be significantly reduced while a carbon dioxide recovery rate of 90% or more is maintained.

(5) In the carbon dioxide recovery method according to any one of (1) to (4), it is preferable that the aqueous amine solution be at least one of an aqueous IPAE solution and a mixed aqueous solution of an aqueous IPAE solution and an aqueous TMDAH solution.

The aqueous IPAE solution or the mixed aqueous solution of an aqueous IPAE solution and an aqueous TMDAH solution as the absorbing solution has properties that a rate of change in the absorbed amount of carbon dioxide relative to the temperature change gradually decreases as the temperature increases in the heating temperature range in the carbon dioxide separation step, that is, properties exhibiting a downward convex curve. Therefore, when these aqueous solutions are used, the thermal energy requirement can be significantly reduced while a carbon dioxide recovery rate of 90% or more is maintained.

(6) In the carbon dioxide recovery method according to any one of (1) to (5), it is preferable that a reboiler used when the absorbing solution is heated in the carbon dioxide separation step be provided with a stirrer to stir the absorbing solution stored in the reboiler by the stirrer.

When the heating temperature of the aqueous amine solution at the time of carbon dioxide separation is set within the range of 87° C. to 100° C., there is a concern of lowering a carbon dioxide release rate and thus the size of the reboiler needs to be increased to avoid the above concern.

However, when the absorbing solution stored in the reboiler is stirred by the stirrer as in the present invention, heat transfer on a heat transfer surface in the reboiler can be improved and the heating rate can be increased while unevenness in the temperature of the absorbing solution in the reboiler is reduced. Also, the thickness of a carbon dioxide laminar film of a liquid surface in the reboiler is reduced and thus the carbon dioxide release rate can be increased. That is, the carbon dioxide release rate can be increased without increasing the size of the reboiler.

(7) In the carbon dioxide recovery method according to any one of (1) to (6), it is preferable that the reboiler used when the absorbing solution is heated in the carbon dioxide separation step be provided with an absorbing solution circulation system to extract some of the absorbing solution stored in the reboiler by the absorbing solution circulation system and spray the extracted absorbing solution into the reboiler again by a shower nozzle.

Even in this case, the carbon dioxide release rate can be increased without increasing the size of the reboiler as in the above-described case in which the reboiler is provided with the stirrer.

(8) In the carbon dioxide recovery method according to (6) or (7), a heating source supplied to the reboiler may be low temperature water vapor of substantially 110° C.

In the present invention, since the heating temperature of the aqueous amine solution at the time of carbon dioxide separation is 87° C. to 100° C., as the heating source, for example, low temperature water vapor of substantially 110° C. which is not very useful and typically disposed of (water vapor discharged from other processes after use) can be utilized. Therefore, an operation cost can be significantly lowered.

(9) According to another aspect of the present invention, a carbon dioxide recovery device includes an absorption tower that causes an absorbing solution to be brought into contact with a gas to be treated including carbon dioxide to absorb the carbon dioxide in the gas to be treated, and a regeneration tower that regenerates the absorbing solution by separating the carbon dioxide from the absorbing solution with heating of the absorbing solution in which the carbon dioxide is absorbed, wherein an aqueous amine solution having properties that a rate of change in an absorbed amount of carbon dioxide relative to a temperature change gradually decreases as the temperature increases in a heating temperature range in the carbon dioxide separation step is used as the absorbing solution, the regeneration tower includes a reboiler that heats the absorbing solution, the reboiler is provided with a temperature control unit that controls the temperature of the absorbing solution in the reboiler, and the temperature control unit controls the heating temperature of the absorbing solution to be within a range of 87° C. to 100° C.

In the present invention, the aqueous amine solution having properties that a rate of change in the absorbed amount of carbon dioxide relative to the temperature change gradually decreases as the temperature increases in the heating temperature range in the carbon dioxide separation step is used. In this case, even when the regeneration temperature of the absorbing solution is changed from, for example, 120° C. to 100° C., the remaining amount of carbon dioxide in the lean absorbing solution (absorbing solution after regeneration) is not increased much and a relatively small remaining amount of carbon dioxide is maintained. Therefore, even when the carbon dioxide is absorbed in the carbon dioxide absorption step, which is the subsequent step, in the absorption tower using such a lean absorbing solution having a low regeneration temperature, the absorbed amount of carbon dioxide is not decreased much and a relatively large amount of absorbed carbon dioxide can be secured.

As a result, compared to the carbon dioxide recovery method of the related art, the thermal energy requirement can be reduced while a carbon dioxide recovery rate of 90% or more is maintained.

(10) In the carbon dioxide recovery device according to (9), it is preferable that the temperature control unit control the heating temperature of the absorbing solution to be within a range of 90° C. to 97° C.

When the carbon dioxide is recovered within such a temperature range, compared to the carbon dioxide recovery method of the related art, the thermal energy requirement can be reduced while a carbon dioxide recovery rate of 90% or more is maintained.

(11) In the carbon dioxide recovery device according to (9) or (10), it is preferable that the regeneration tower include a pressure control valve that controls pressure of the regeneration tower, and the pressure of the regeneration tower be adjusted to a gauge pressure of 0.02 MPaG to 0.13 MPaG.

When the carbon dioxide is recovered within such a pressure range, the thermal energy requirement can be significantly reduced while a carbon dioxide recovery rate of 90% or more is maintained.

(12) In the carbon dioxide recovery device according to any one of (9) to (11), it is preferable that the aqueous amine solution having a ratio Xa/Xb of 0.77 or more be used, the ratio Xa/Xb being a ratio of a difference Xa in the absorbed amount of carbon dioxide when the temperature of the aqueous amine solution is changed from 40° C. to 95° C. to a difference Xb in the absorbed amount of carbon dioxide when the temperature of the aqueous amine solution is changed from 40° C. to 120° C., under a condition of a carbon dioxide partial pressure of 60 kPa to 80 kPa.

A high ratio Xa/Xb means that even when the temperature of the absorbing solution in the carbon dioxide absorption step is changed from 120° C. to 95° C., the remaining amount of carbon dioxide in a lean absorbing solution (absorbing solution after regeneration) is not increased much and a relatively small remaining amount of carbon dioxide is maintained. Therefore, since the aqueous amine solution used in the carbon dioxide absorption method of the present invention has a ratio Xa/Xb being 0.77 or more, the thermal energy requirement can be significantly reduced while a carbon dioxide recovery rate of 90% or more is maintained.

(13) In the carbon dioxide recovery device according to any one of (9) to (12), it is preferable that at least one of an aqueous IPAE solution and a mixed aqueous solution of an aqueous IPAE solution and an aqueous TMDAH solution be used as the aqueous amine solution.

The aqueous IPAE solution or the mixed aqueous solution of an aqueous IPAE solution and an aqueous TMDAH solution as the absorbing solution has properties that a rate of change in the absorbed amount of carbon dioxide relative to the temperature change gradually decreases as the temperature increases in the heating temperature range in the carbon dioxide separation step, that is, properties exhibiting a downward convex curve. Therefore, when these aqueous solutions are used, the thermal energy requirement can be significantly reduced while a carbon dioxide recovery rate of 90% or more is maintained.

(14) It is preferable that the carbon dioxide recovery device according to any one of (9) to (13) further include a stirrer that is provided in a reboiler to stir the absorbing solution stored in the reboiler.

When the absorbing solution stored in the reboiler is stirred by the stirrer, heat transfer on a heat transfer surface in the reboiler can be improved and the heating rate can be increased while unevenness in the temperature of the absorbing solution in the reboiler is reduced. Also, the thickness of a carbon dioxide laminar film of a liquid surface in the reboiler is reduced and thus the carbon dioxide release rate can be increased. That is, the carbon dioxide release rate can be increased without increasing the size of the reboiler.

(15) In the carbon dioxide recovery device according to (14), it is preferable that the stirrer be arranged at a position of a liquid surface of the absorbing solution to stir the absorbing solution.

When the stirrer is arranged at the position of the liquid surface of the absorbing solution, the lean absorbing solution can be more easily brought into contact with the gas at the time of stirring and carbon dioxide separation from the lean absorbing solution can be promoted.

(16) In the carbon dioxide recovery device according to any one of (9) to (15), it is preferable that the reboiler include an absorbing solution circulation system, and the absorbing solution circulation system include a branch pipe that extracts some of the absorbing solution stored in the reboiler and a shower nozzle that sprays the extracted absorbing solution into the reboiler again.

Even in this case, the carbon dioxide release rate can be increased without increasing the size of the reboiler as in the above-described case in which the reboiler is provided with the stirrer.

(17) It is preferable that the carbon dioxide recovery device according to (9) further include a heat exchanger that is interposed in an absorbing solution discharge pipe which connects an absorbing solution outlet of the absorption tower and an absorbing solution inlet of the regeneration tower and is interposed in an absorbing solution return pipe which connects an absorbing solution inlet of the absorption tower and an absorbing solution outlet of the regeneration tower to exchange heat of the absorbing solution in which the carbon dioxide is absorbed and the regenerated absorbing solution.

When a rich absorbing solution discharged from the absorption tower passes through the heat exchanger through a rich absorbing solution discharge pipe, the rich absorbing solution is heated to a predetermined temperature by a lean absorbing solution flowing out from the regeneration tower and flows into the regeneration tower. When the lean absorbing solution in the regeneration tower passes through the heat exchanger through a lean absorbing solution return pipe, the temperature of the lean absorbing solution is decreased to a predetermined temperature by the rich absorbing solution. The heating of the rich absorbing solution and the cooling of the absorbing solution can be carried out by exchanging heat of the rich absorbing solution and the lean absorbing solution with each other.

(18) The carbon dioxide recovery device according to (17) may further include a heat exchanger that is provided in the absorbing solution return pipe between the absorbing solution inlet of the absorption tower and the heat exchanger to further cool the absorbing solution.

When the lean absorbing solution is further cooled, the absorbed amount of carbon dioxide in the lean absorbing solution can be increased and as a result, a carbon dioxide recovery rate can be improved.

### Advantageous Effects of Invention

According to the invention of the present application, the thermal energy requirement can be reduced while a carbon dioxide recovery rate of 90% or more is maintained. In addition, the carbon dioxide release rate can be increased without increasing the size of the reboiler.

### BRIEF DESCRIPTION OF DRAWINGS

FIG. 1 is a diagram illustrating properties of an absorbing solution used in a carbon dioxide recovery method according to the present invention.

FIG. 2 is a diagram showing a configuration of a carbon dioxide recovery device for carrying out the carbon dioxide recovery method according to the present invention.

FIG. 3 is a side view showing a reboiler of the carbon dioxide recovery device for carrying out the carbon dioxide recovery method according to the present invention.

FIG. 4 is a diagram showing a relationship between a regeneration temperature of the absorbing solution and a thermal energy requirement in a carbon dioxide separation step.

FIG. 5 is a diagram showing a relationship between a gauge pressure in a regeneration tower and a thermal energy requirement in the carbon dioxide separation step.

FIG. 6 is a diagram showing a relationship between the regeneration temperature of the absorbing solution and the maximum pressure in the regeneration tower in the carbon dioxide separation step.

### DESCRIPTION OF EMBODIMENTS

Hereinafter, preferred embodiments of the present invention will be described with reference to the accompanying drawings.

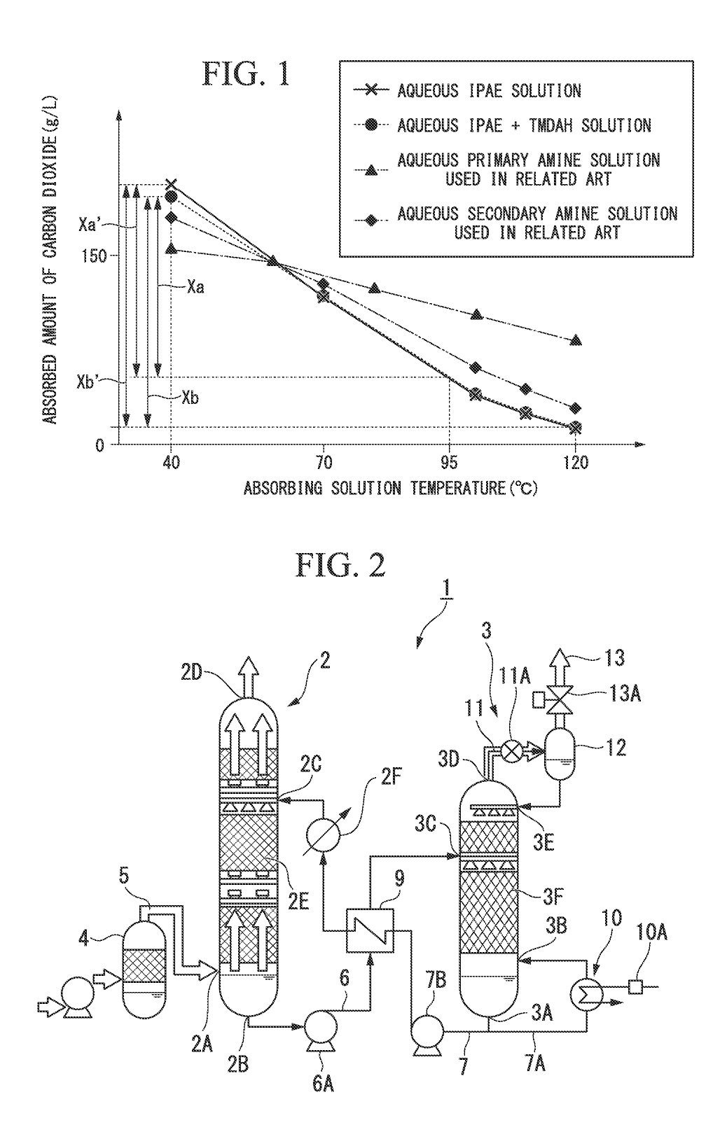

First, a specific aqueous amine solution that is an absorbing solution to be used in a carbon dioxide recovery method according to the present invention will be described. FIG. 1 is a diagram illustrating the properties of the aqueous amine solution. In the drawing, the vertical axis represents an absorbed amount of carbon dioxide and the horizontal axis represents a temperature of the absorbing solution, respectively.

The aqueous amine solution used in the present invention has a tendency that the rate of change in the absorbed amount of carbon dioxide relative to the temperature change gradually increases as the temperature increases in a range of 40° C. to 55° C., is substantially constant in a range of 55° C. to 90° C., and gradually decreases as the temperature increases in a range higher than 90° C. That is, as seen from the drawing, the aqueous amine solution used in the present invention has properties exhibiting a downward convex curve in a heating temperature range of 70° C. or higher in the carbon dioxide separation step.

For comparison, in FIG. 1, the properties of a primary aqueous amine solution (for example, monoethanolamine (MEA)) and a secondary aqueous amine solution (for example, ethylaminoethanol (EAE)), which have been generally used as an absorbing solution for carbon dioxide in the related art, are shown. Both the primary aqueous amine solution and the secondary aqueous amine solution, which have been used in the related art, exhibit an substantially constant rate of change in the absorbed amount of carbon dioxide relative to the temperature change in all temperature ranges and also exhibit a constant rate of change in a heating temperature range of 70° C. or higher in the carbon dioxide separation step.

Examples of the aqueous amine solution used in the present invention include an aqueous solution of isopropyl amino ethanol (IPAE), and a mixed aqueous solution of isopropyl amino ethanol (IPAE) and tetramethyl diaminohexane (TMDAH).

The example shown in FIG. 1 is an example in which an aqueous IPAE solution or a mixed aqueous solution of an aqueous IPAE solution and an aqueous TMDAH solution is used as the absorbing solution. In addition, the properties shown in FIGS. 4 to 6 to be described later are exhibited also in the example in which the aqueous IPAE solution or the mixed aqueous solution of an aqueous IPAE solution and an aqueous TMDAH solution is used as the absorbing solution.

As seen from the graph shown in FIG. 1, the aqueous IPAE solution has properties that the rate of change in the absorbed amount of carbon dioxide relative to a temperature change gradually decreases as the temperature increases in a heating temperature range in the carbon dioxide separation step, that is, properties exhibiting a downward convex curve.

In the aqueous IPAE solution, a ratio Xa/Xb of a difference Xa in the absorbed amount of carbon dioxide when the temperature of the aqueous IPAE solution was changed from 40° C. (absorbing solution temperature in the general carbon dioxide absorption step) to 95° C. (exemplary temperature within an absorbing solution temperature range in the carbon dioxide separation step used in the carbon dioxide absorption method of the present invention) to a difference Xb in the absorbed amount of carbon dioxide when the temperature of the aqueous IPAE solution was changed from 40° C. (absorbing solution temperature in a general carbon dioxide absorption step) to 120° C. (absorbing solution temperature in a carbon dioxide absorption step generally used in the related art) under a condition of a carbon dioxide partial pressure of 60 kPa to 80 kPa was 0.79.

Further, in the mixed aqueous solution of an aqueous IPAE solution and an aqueous TMDAH solution used in the present invention, a ratio Xa/Xb of a difference Xa in the absorbed amount of carbon dioxide when the temperature of the mixed aqueous solution of an aqueous IPAE solution and an aqueous TMDAH solution was changed from 40° C. (absorbing solution temperature in a general carbon dioxide absorption step) to 95° C. (exemplary temperature within the absorbing solution temperature range in the carbon dioxide separation step used in the carbon dioxide absorption method of the present invention) to a difference Xb in the absorbed amount of carbon dioxide when the temperature of the mixed aqueous solution of an aqueous IPAE solution and an aqueous TMDAH solution was changed from 40° C. (absorbing solution temperature in a general carbon dioxide absorption step) to 120° C. (absorbing solution temperature in a carbon dioxide absorption step generally used in the related art) under a condition of a carbon dioxide partial pressure of 60 KPa to 80 KPa was 0.77.

The specific numerical values of the aqueous IPAE solution or the mixed aqueous solution of an aqueous IPAE solution and an aqueous TMDAH solution will be shown in the following Table 1.

TABLE 1

| | |
|---|---|
| Aqueous IPAE + | Aqueous IPAE |
| TMDAH solution | solution |

| | | | | |
|---|---|---|---|---|
| Absorbed amount of | 197 | g/L | 206 | g/L |
| carbon dioxide at 40° C. | | | | |
| Absorbed amount of | 60 | g/L | 57 | g/L |
| carbon dioxide at 95° C. | | | | |
| Absorbed amount of | 19.7 | g/L | 16.5 | g/L |
| carbon dioxide at 120° C. | | | | |

| | | |
|---|---|---|
| Xa (Xa′) | 197 − 60 = | 206 − 57 = |
| | 137(g/L) | 149(g/L) |
| Xb (Xb′) | 197 − 19.7 = | 206 − 16.5 = |
| | 177.3(g/L) | 189.5(g/L) |
| Xa/Xb (Xa′/Xb′) | 0.773 | 0.786 |

In addition, when the investigation of the same ratio was carried out in a case of using a secondary aqueous amine solution as an example, a ratio Xc/Xd of a difference Xc in the absorbed amount of carbon dioxide when the temperature of the aqueous amine solution was changed from 40° C. to 95° C. to a difference Xd in the absorbed amount of carbon dioxide when the temperature of the aqueous amine solution was changed from 40° C. to 120° C. was 0.72.

A high ratio means that even when the temperature of the absorbing solution in the carbon dioxide absorption step is changed from 120° C. to 95° C., the remaining amount of carbon dioxide in a lean absorbing solution (absorbing solution after regeneration) is not increased much and a relatively small remaining amount of carbon dioxide is maintained.

The aqueous amine solution used in the carbon dioxide absorption method of the present invention preferably has a ratio Xa/Xb of 0.77 or more, and more preferably a ratio of 0.8 or more.

FIG. 2 is a diagram showing a configuration of a carbon dioxide recovery device for carrying out the carbon dioxide recovery method according to the present invention. A carbon dioxide absorption device 1 includes an absorption tower 2 and a regeneration tower 3. The absorption tower 2 causes a gas to be treated containing carbon dioxide to be brought into contact with a lean absorbing solution and causes the lean absorbing solution to absorb the carbon dioxide in the gas to be treated. The regeneration tower 3 regenerates the lean absorbing solution by heating a rich absorbing solution and separating the carbon dioxide while supplying the rich absorbing solution including a large amount of absorbed carbon dioxide from the absorption tower 2.

At the bottom portion of the absorption tower 2, a treated gas inlet 2A and a rich absorbing solution outlet 2B that discharges the rich absorbing solution are formed. A gas supply pipe 5 in which a dust collector 4 is interposed is connected to the treated gas inlet 2A and the gas to be treated is introduced into the absorption tower 2 from the treated gas inlet 2A through the gas supply pipe 5. A rich absorbing solution discharge pipe 6 is connected to the rich absorbing solution outlet 2B. At the bottom portion of the absorption tower 2, a lean absorbing solution inlet 2C that returns the lean absorbing solution and a gas outlet 2D are formed. A lean absorbing solution return pipe 7 is connected to the lean absorbing solution inlet 2C.

The lean absorbing solution in the absorption tower 2 is brought into contact with the gas to be treated through a filling tank 2E made of a metal steel plate or a resin. At the bottom portion of the absorption tower 2, the treated gas inlet 2A is provided in the upper portion of the rich absorbing solution outlet 2B and is provided in the upper portion of the liquid surface of the rich absorbing solution. At the top portion of the absorption tower 2, the lean absorbing solution inlet 2C is provided in the lower portion of the gas outlet 2D.

In the absorption tower 2, when the absorbing solution in a lean state which is supplied from the lean absorbing solution inlet 2C flows downward in the filling tank 2E in the tower, the absorbing solution is brought into contact with the gas to be treated supplied from the treated gas inlet 2A and absorbs the carbon dioxide in the gas to be treated with an exothermic reaction to produce a rich absorbing solution. The absorbing solution in a rich state is discharged from the rich absorbing solution outlet 2B. In addition, the gas to be treated from which carbon dioxide has been separated is discharged from the gas outlet 2D.

Further, the lean absorbing solution and the rich absorbing solution used herein are solutions based on carbon dioxide density. An absorbing solution in which the carbon dioxide density is less than a predetermined density is referred to as a lean absorbing solution and an absorbing solution in which the carbon dioxide density is equal to or more than a predetermined density is referred to as a rich absorbing solution.

At the bottom portion of the regeneration tower 3, a lean absorbing solution outlet 3A that discharges the lean absorbing solution is formed. The lean absorbing solution return pipe 7 is connected to the lean absorbing solution outlet 3A. A branch pipe 7A extends from the lean absorbing solution return pipe 7, a reboiler 10 is interposed in the branch pipe 7A, and the tip end of the branch pipe is connected to an absorbing solution return port 3B of the lower portion of the regeneration tower 3. In the reboiler 10, a temperature control unit 10A for controlling the temperature of the absorbing solution in the reboiler is provided.

At the top portion of the regeneration tower 3, a rich absorbing solution inlet 3C that returns the rich absorbing solution and a gas outlet 3D are formed. The rich absorbing solution discharge pipe 6 is connected to a rich absorbing solution inlet 3C. A gas exhaust pipe 11 is connected to the gas outlet 3D and a condenser (heat exchanger) 11A that condenses water vapor passing through the gas exhaust pipe 11 and a gas-liquid separator 12 are provided in the gas exhaust pipe 11. The condensed water separated by the gas-liquid separator 12 is returned to a condensed water return port 3E in the upper portion of the regeneration tower 3 and the carbon dioxide separated by the gas-liquid separator 12 is recovered through a gas pipe 13 in which a pressure control valve 13A that controls the pressure of the regeneration tower 3 is interposed.

In the regeneration tower 3, the carbon dioxide is also separated by a separation of carbon dioxide of when the rich absorbing solution flowing from the rich absorbing solution inlet 3C flows downward in a filling tank 3F made of a metal steel plate or a resin arranged in the tower and by heating of the carbon dioxide by the reboiler 10. At this time, water vapor is also simultaneously separated from the rich absorbing solution. The rich absorbing solution from which carbon dioxide or the like has been separated is regenerated to produce a lean absorbing solution and the lean absorbing solution is discharged from the lean absorbing solution outlet 3A. Further, the separated carbon dioxide and water vapor are discharged from the gas outlet 3D to the outside of the tower.

A pump 6A and a heat exchanger 9 are interposed in the rich absorbing solution discharge pipe 6 which connects the rich absorbing solution outlet 2B of the absorption tower 2 and the rich absorbing solution inlet 3C of the regeneration tower 3. When the rich absorbing solution discharged from the absorption tower 2 passes through the heat exchanger 9 through the rich absorbing solution discharge pipe 6, the rich absorbing solution is heated to a predetermined temperature by the lean absorbing solution flowing out from the regeneration tower and flows into the regeneration tower 3. Further, a pump 7B and the heat exchanger 9 are interposed in the lean absorbing solution return pipe 7 which connects the lean absorbing solution inlet 2C of the absorption tower 2 and the lean absorbing solution outlet 3A of the regeneration tower 3. When the lean absorbing solution in the regeneration tower 3 passes through the heat exchanger 9 through the lean absorbing solution return pipe 7, the lean absorbing solution is cooled to a predetermined temperature by the rich absorbing solution and is returned to the absorption tower 2. In addition, as necessary, a heat exchanger 2F which further cools the lean absorbing solution may be arranged between the heat exchanger 9 and the absorption tower 2 in the lean absorbing solution return pipe 7. When the lean absorbing solution is further cooled, the absorbed amount of carbon dioxide in the lean absorbing solution can be increased and as a result, carbon dioxide recovery efficiency can be improved.

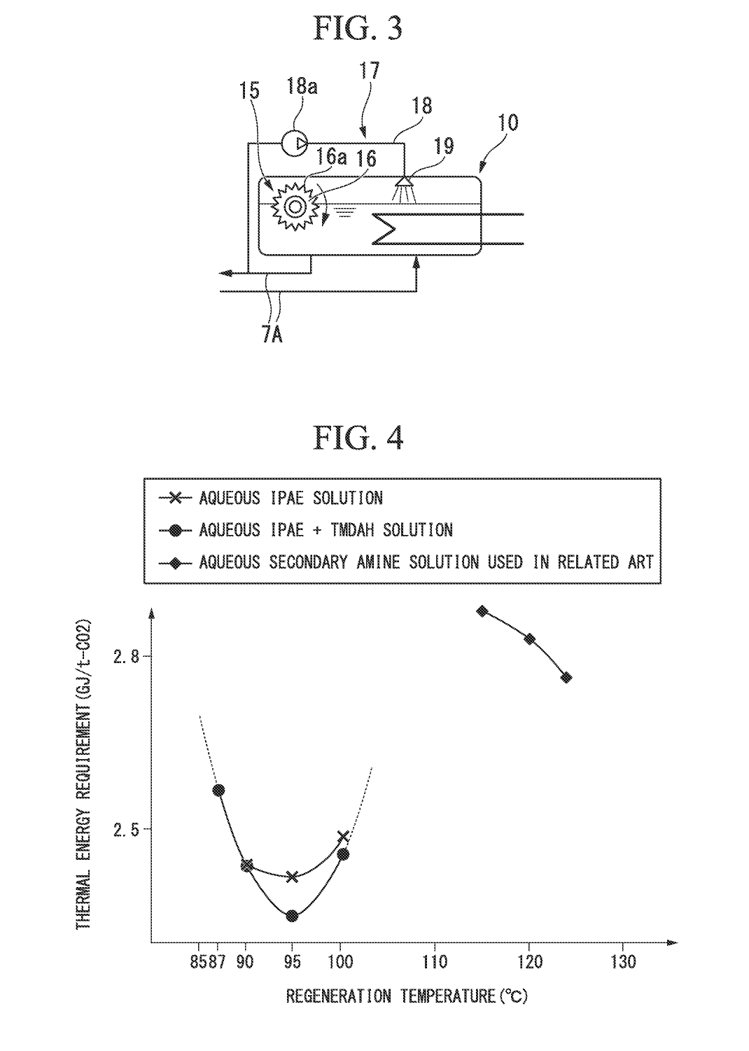

FIG. 3 is a side view showing the details of the above-described reboiler 10. As shown in the drawing, a stirrer 15 is provided in the reboiler 10. The stirrer 15 is configured such that, for example, a rotating body 16 having multiple blades 16a on the outer periphery is rotated by driving means such as a motor (not shown). The lean absorbing solution stored in the reboiler 10 is stirred by the stirrer 15 to make the temperature uniform. In addition, in the embodiment, the stirrer 15 is arranged at the position of the liquid surface of the lean absorbing solution so that the lean absorbing solution is more easily brought into contact with the gas at the time of stirring and carbon dioxide separation from the lean absorbing solution is promoted.

Further, an absorbing solution circulation system 17 is provided in the reboiler 10. The absorbing solution circulation system 17 is configured to extract some of the lean absorbing solution stored in the reboiler 10 from the branch pipe 7A through a pipe 18 in which a pump 18a is interposed and to spray the extracted lean absorbing solution toward the rich absorbing solution in the reboiler again by a shower nozzle 19 arranged above the liquid surface in the reboiler.

Next, the carbon dioxide recovery method using the carbon dioxide recovery device will be described.

Dust is removed from the gas to be treated by the dust collector 4 and then the gas to be treated flows into the absorption tower 2 through the gas supply pipe 5. The gas to be treated flowing into the absorption tower 2 is brought into contact with the lean absorbing solution supplied from the lean absorbing solution return pipe 7 to the top portion of the absorption tower 2 in the filling tank 2E and the contained carbon dioxide is absorbed by the lean absorbing solution with an exothermic reaction. The gas to be treated from which carbon dioxide has been removed is discharged from the gas outlet 2D in the top portion of the tower to the outside of the tower.

The temperature at the time of absorption of carbon dioxide by the lean absorbing solution in the absorption tower 2 is set within a range of room temperature to 60° C. or lower, and preferably set within a range of 30° C. to 40° C.

In addition, the pressure in the absorption tower 2 at the time of absorption of carbon dioxide is set to be substantially the same as the atmospheric pressure. In order to improve absorbing performance, the pressure can be increased to a higher pressure. However, the energy required for compression needs to be consumed and thus the absorption of the carbon dioxide needs to be carried out under the atmospheric pressure to suppress the energy consumption.

On the other hand, the absorbing solution which absorbs the carbon dioxide and is in a rich state is discharged from the rich absorbing solution outlet 2B at the bottom portion of the tower by the rich absorbing solution discharge pipe 6. The discharged rich absorbing solution is pressurized by the pump 6A, heated by the absorbing solution in a lean state through the heat exchanger 9, and then transported into the regeneration tower 3. Here, the rich absorbing solution is heated to an appropriate temperature when the rich absorbing solution passes through the heat exchanger 9 and further heated by being brought into contact with high temperature carbon dioxide and water vapor produced at the bottom portion of the tower which will be described later. Then, when the rich absorbing solution flows downward in the filling tank 3F in the regeneration tower 3, carbon dioxide is separated from the rich absorbing solution and some water vapor is also separated at the same time. When the absorbing solution from which carbon dioxide has been separated and which has been in a lean state is heated by the reboiler 10 at the bottom portion of the tower, carbon dioxide remaining in the absorbing solution is separated from the absorbing solution. The lean absorbing solution from which carbon dioxide is separated and which has been regenerated is discharged from the lean absorbing solution outlet 3A at the bottom portion of the tower by the lean absorbing solution return pipe 7. The discharged lean absorbing solution is pressurized by the pump 7B, cooled to an appropriate temperature by the absorbing solution in a rich state through the heat exchanger 9, and then transported into the absorption tower 2.

Here, in the carbon dioxide recovery method of the present invention, the regeneration temperature of the absorbing solution in the regeneration tower 3 is set to a relatively low temperature range of 87° C. to 100° C. by the temperature control unit 10A. However, the aqueous amine solution having properties that the rate of change in the absorbed amount of carbon dioxide relative to the temperature change gradually decreases as the temperature increases in a heating temperature range in the carbon dioxide separation step as shown in FIG. 1 is used, and thus, although the temperature is set to a relatively low regeneration temperature, the remaining amount of carbon dioxide in the lean absorbing solution (absorbing solution after regeneration) is not increased much and a relatively small remaining amount of carbon dioxide is maintained. Therefore, even when carbon dioxide is absorbed in the absorption tower 2 in the subsequent step, using such a lean absorbing solution having a low regeneration temperature, the absorbed amount of carbon dioxide is not decreased much and a relatively large amount of absorbed carbon dioxide can be secured.

FIG. 4 is a diagram showing a relationship between a regeneration temperature of the absorbing solution and a thermal energy requirement in a carbon dioxide separation step in a state in which a carbon dioxide recovery rate of 90% or more is maintained. FIG. 4 shows cases in which a secondary aqueous amine solution which is used in the related art, an aqueous IPAE solution, and a mixed aqueous solution of IPAE and TMDAH are used. The horizontal axis represents a regeneration temperature of the absorbing solution and the vertical axis represents a thermal energy requirement. Further, the gauge pressure in the regeneration tower 3 when the data was acquired was 0.06 MPaG.

As seen from the drawing, when the regeneration temperature of the absorbing solution was set to 100° C. to 87° C., the thermal energy requirement was reduced to a low value. However, when the regeneration temperature was further lowered to a temperature lower than 87° C., the thermal energy requirement was rapidly deteriorated to maintain a carbon dioxide recovery rate of 90% or more.

For comparison, a change in the thermal energy requirement when secondary amine is used as the absorbing solution and the gauge pressure in the regeneration tower is set to 0.1 MPaG to 0.3 MPaG is also shown in the drawing. In the carbon dioxide recovery method of the related art using secondary amine, it was found that the thermal energy requirement was very high compared to the carbon dioxide recovery method of the present invention.

From these results, it was found that the thermal energy requirement was able to be reduced while a carbon dioxide recovery rate of 90% or more was maintained according to the carbon dioxide recovery method of the present invention, compared to the carbon dioxide recovery method of the related art.

From the drawing, it is found that the regeneration temperature of the absorbing solution is preferably set to 90° C. to 97° C., and more preferably set to substantially 95° C. from the viewpoint of reducing the thermal energy requirement.

In the present invention, since the heating temperature of the aqueous amine solution is 87° C. to 100° C. at the time of carbon dioxide separation, as a heating source, for example, low temperature water vapor of substantially 110° C. which is not very useful and typically subjected to cold condensation or disposed of (water vapor discharged from other processes after use) can be utilized and thus an operation cost can be significantly lowered.

In the related art, in order to maintain a recovery rate of 90% or more and reduce the thermal energy requirement, the regeneration temperature of an aqueous amine solution generally used as a carbon dioxide absorbing solution needs to be set to substantially 120° C. At this time, when the pressure in the regeneration tower is lowered, the recovered amount of carbon dioxide is increased but the amount of water vapor released from the upper portion of the regeneration tower is also increased. Thus, whether the thermal energy unit requirement is improved or deteriorated depends on the properties of the absorbing solution.

In the present invention, as described above, since the aqueous amine solution having the properties shown in FIG. 1 is used, a high carbon dioxide recovery rate can be maintained even in a case in which the regeneration temperature is lowered to 100° C. or lower. When the regeneration temperature is set to 87° C. or 100° C., the regeneration temperature is equal to or lower than the boiling point of the aqueous amine solution (substantially 110° C. to 120° C.) and the water vapor partial pressure in the regeneration tower is significantly lowered compared to a case in which the regeneration temperature is 120° C. Even when the pressure in the regeneration tower is lowered, the amount of water vapor released from the upper portion of the regeneration tower can be suppressed to be small. On the other hand, the lower the pressure in the regeneration tower is, the more the amount of carbon dioxide can be recovered. As a result, the thermal energy requirement can be reduced as the pressure of the regeneration tower is lower.

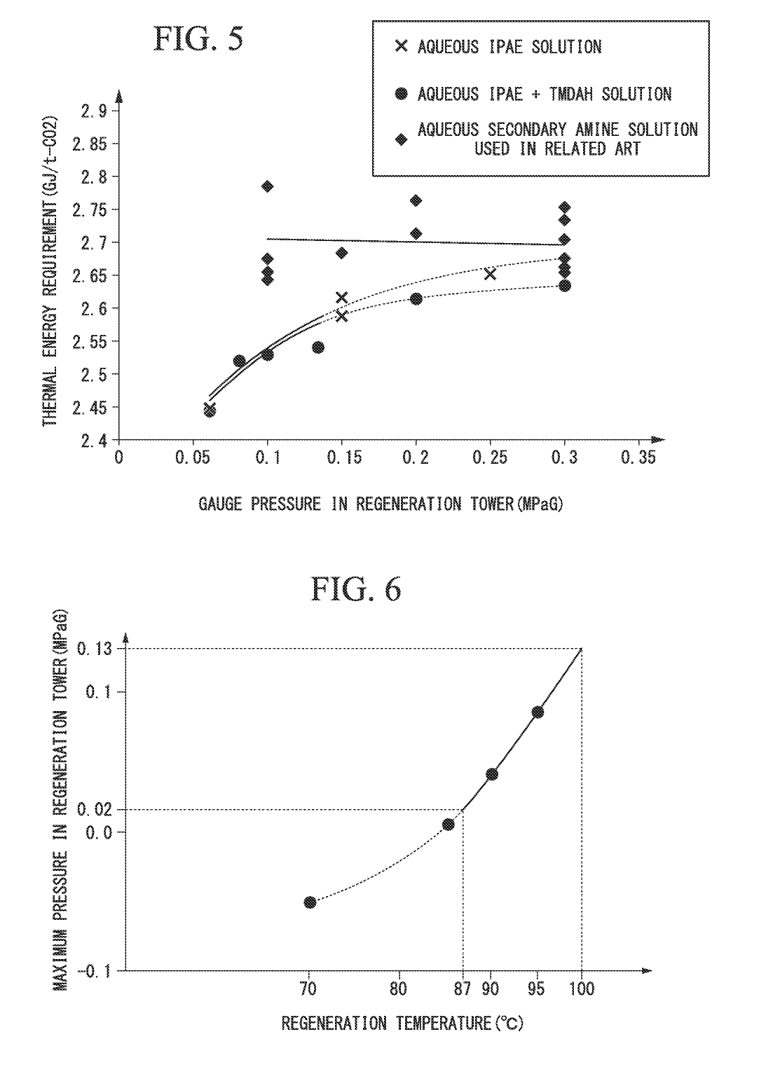

FIG. 5 is a diagram showing a relationship between a gauge pressure in the regeneration tower and a thermal energy requirement in the carbon dioxide separation step in the carbon dioxide recovery method of the present invention. FIG. 5 shows cases in which a secondary aqueous amine solution which is used in the related art, an aqueous IPAE solution, and a mixed aqueous solution of IPAE and TMDAH are used. The horizontal axis represents a gauge pressure in the absorbing solution and the vertical axis represents a thermal energy requirement. From the drawing, it is found that the thermal energy requirement is lower as the pressure of the regeneration tower is lower.

FIG. 6 is a diagram showing a relationship between the regeneration temperature of the absorbing solution and the maximum pressure in the regeneration tower in the carbon dioxide separation step of the carbon dioxide recovery method of the present invention. The horizontal axis represents a regeneration temperature of the absorbing solution and the vertical axis represents the maximum pressure (water vapor partial pressure+carbon dioxide partial pressure) in the regeneration tower. FIG. 6 shows a case in which a mixed aqueous solution of IPAE and TMDAH is used. The aqueous IPAE solution has the same properties as shown in this graph and when being expressed as a graph, the curve overlaps the curve shown in the graph, and thus, the diagram thereof will be omitted.

In regard to a regeneration temperature of 87° C. to 100° C. as a target temperature in the present invention, as the regeneration temperature is higher, the maximum pressure (shutoff pressure) in the regeneration tower is higher, and thus, the maximum value is substantially 0.13 MPaG.

However, as shown in FIG. 5, it is preferable to lower the pressure of the regeneration tower 3 as much as possible from the viewpoint of attaining a good (reduced) thermal energy requirement. Accordingly, the pressure in the regeneration tower 3 controlled by the pressure control valve 13A is preferably 0.08 MPaG or lower and more preferably 0.06 MPaG or lower.

Since the carbon dioxide exhausted from the regeneration tower was returned to the gas pipe having a pressure of substantially 0.04 MPaG in the test, as shown in FIG. 5, a test in which the pressure of the regeneration tower was lowered to 0.06 MPaG or lower was not able to be carried out. However, the thermal energy requirement can be reduced by further lowering the pressure.

On the other hand, the moisture contained in the gas exhausted from the top portion of the regeneration tower 3 needs to be returned into the regeneration tower 3 and condensed in the outlet of the regeneration tower 3 in order to maintain a moisture balance with the absorbing solution. The pressure for compensating a pressure loss in the condenser is required in the outlet of the regeneration tower and thus the lower limit of pressure setting is set to substantially 0.02 MPaG.

In addition, as clearly seen from FIG. 6, since the maximum pressure in the regeneration tower is set to substantially 0.02 MPaG at a regeneration temperature of 87° C., the fact that gauge pressure in the regeneration tower 3 is substantially 0.02 MPaG is appropriate for the lower limit of the pressure.

Further, in the carbon dioxide recovery method of the present invention, when the heating temperature of the aqueous amine solution at the time of carbon dioxide separation is set within a range of 87° C. to 100° C., there is a concern of lowering the release rate of carbon dioxide and the size of the reboiler 10 needs to be increased to avoid the above concern and the retaining time of the aqueous amine solution needs to be increased.

However, in the present invention, the reboiler 10 is provided with the stirrer 15 and the absorbing solution stored in the reboiler 10 is stirred by the stirrer 15.

Accordingly, heat transfer on the heat transfer surface in the reboiler 10 can be improved and the heating rate can be increased while unevenness in the temperature of the absorbing solution in the reboiler 10 is reduced. Also, the thickness of a carbon dioxide laminar film of a liquid surface in the reboiler 10 is reduced and thus the carbon dioxide release rate can be increased. That is, the carbon dioxide release rate can be increased without increasing the size of the reboiler 10.

In addition, in the carbon dioxide recovery method of the present invention, the absorbing solution circulation system 17 is provided in the reboiler 10 and some of the absorbing solution stored in the reboiler 10 is extracted by the absorbing solution circulation system 17 and the extracted absorbing solution is sprayed into the reboiler 10 again by the shower nozzle 19. The unevenness in the temperature of the absorbing solution in the reboiler can also be reduced by the absorbing solution circulation system 17 and the release rate of the carbon dioxide can be increased. Accordingly, the release rate of the carbon dioxide in the reboiler can be further increased.

Although the embodiments of the present invention have been described in detail with reference to the drawings above, the specific configuration is not limited to these embodiments and design modifications without departing from the scope of the present invention are also included.

In the above-described embodiment, the stirrer 15 and the absorbing solution circulation system 17 are provided in the reboiler 10. However, these components are not necessarily required. A configuration including either of the components or a configuration not including both the components may be adopted.

In addition, in the above-described embodiment, one reboiler 10 is arranged but multiple stages of reboilers 10 may be arranged as necessary.

Further, in the embodiment, when carbon dioxide is separated from the absorbing solution in the regeneration tower 3, the method including dropping the absorbing solution along the filling tank 3F which is made of a metal steel plate or a resin and provided in the regeneration tower 3 to widen the liquid interface of the absorbing solution and heating the absorbing solution at the same time is adopted, but the embodiment is not limited thereto. A separation method including heating and bubbling the aqueous solution using a pot as in distillation and a carbon dioxide separation method of using a spray tower may be adopted.

### INDUSTRIAL APPLICABILITY

According to the carbon dioxide recovery method of the present invention, the thermal energy requirement can be reduced while a high carbon dioxide recovery rate is maintained. In addition, the release rate of the carbon dioxide can be increased without increasing the size of the reboiler.

### REFERENCE SIGNS LIST

1: CARBON DIOXIDE ABSORPTION DEVICE
2: ABSORPTION TOWER
3: REGENERATION TOWER
3A: LEAN ABSORBING SOLUTION OUTLET
3B: RETURN PORT
3C: RICH ABSORBING SOLUTION INLET
3D: GAS OUTLET
3F: FILLING TANK
6: RICH ABSORBING SOLUTION DISCHARGE PIPE
7: LEAN ABSORBING SOLUTION RETURN PIPE
7A: BRANCH PIPE
8: CIRCULATION CIRCUIT
9: HEAT EXCHANGER
10: REBOILER
10A: TEMPERATURE CONTROL UNIT
13A: PRESSURE CONTROL VALVE
12: GAS-LIQUID SEPARATOR
15: STIRRER
16: ROTATING BODY
16a: BLADE
17: ABSORBING SOLUTION CIRCULATION SYSTEM
18: PIPE
19: SHOWER NOZZLE

1. A carbon dioxide recovery method comprising:
a carbon dioxide absorption step of bringing an absorbing solution into contact with a gas to be treated including carbon dioxide to absorb the carbon dioxide in the gas to be treated; and
a carbon dioxide separation step of separating the carbon dioxide from the absorbing solution with heating of the absorbing solution in which the carbon dioxide is absorbed,
wherein an aqueous amine solution having properties that a rate of change in an absorbed amount of carbon dioxide relative to a temperature change gradually decreases as the temperature increases in a heating temperature range in the carbon dioxide separation step is used as the absorbing solution,
the aqueous amine solution has a ratio Xa/Xb being 0.77 or more, the ratio Xa/Xb being a ratio of a difference Xa in the absorbed amount of carbon dioxide when the temperature of the aqueous amine solution is changed from 40° C. to 95° C. to a difference Xb in the absorbed amount of carbon dioxide when the temperature of the aqueous amine solution is changed from 40° C. to 120° C., under a condition of a carbon dioxide partial pressure of 60 kPa to 80 kPa,
the aqueous amine solution is at least one of an aqueous IPAE solution and a mixed aqueous solution of an aqueous IPAE solution and an aqueous TMDAH solution,
the carbon dioxide separation step is carried out under a condition of a gauge pressure of 0.02 MPaG to 0.08 MPaG, and
the heating temperature of the absorbing solution in the carbon dioxide separation step is within a range of 87° C. to 100° C.

2. The carbon dioxide recovery method according to claim 1, wherein the heating temperature of the absorbing solution in the carbon dioxide separation step is within a range of 90° C. to 97° C.

3. (canceled)

4. (canceled)

5. (canceled)

6. The carbon dioxide recovery method according to claim 1, wherein
a reboiler used when the absorbing solution is heated in the carbon dioxide separation step is provided with a stirrer to stir the absorbing solution stored in the reboiler by the stirrer.

7. The carbon dioxide recovery method according to claim 1, wherein
the reboiler used when the absorbing solution is heated in the carbon dioxide separation step is provided with an absorbing solution circulation system to extract some of the absorbing solution stored in the reboiler by the absorbing solution circulation system and spray the extracted absorbing solution into the reboiler again by a shower nozzle.

8. The carbon dioxide recovery method according to claim 6, wherein
a heating source supplied to the reboiler is low temperature water vapor of substantially 110° C.

9. A carbon dioxide recovery device comprising:
an absorption tower that causes an absorbing solution to be brought into contact with a gas to be treated including carbon dioxide to absorb the carbon dioxide in the gas to be treated; and
a regeneration tower that regenerates the absorbing solution by separating the carbon dioxide from the absorbing solution with heating of the absorbing solution in which the carbon dioxide is absorbed,
wherein an aqueous amine solution having properties that a rate of change in an absorbed amount of carbon dioxide relative to a temperature change gradually decreases as the temperature increases in a heating temperature range in the carbon dioxide separation step is used as the absorbing solution,
the aqueous amine solution having a ratio Xa/Xb of 0.77 or more is used, the ratio Xa/Xb being a ratio of a difference Xa in the absorbed amount of carbon dioxide when the temperature of the aqueous amine solution is changed from 40° C. to 95° C. to a difference Xb in the absorbed amount of carbon dioxide when the temperature of the aqueous amine solution is changed from 40° C. to 120° C., under a condition of a carbon dioxide partial pressure of 60 kPa to 80 kPa,
at least one of an aqueous IPAE solution and a mixed aqueous solution of an aqueous IPAE solution and an aqueous TMDAH solution is used as the aqueous amine solution,
the regeneration tower includes a reboiler that heats the absorbing solution and a pressure control valve that controls pressure of the regeneration tower,
the reboiler is provided with a temperature control unit that controls the temperature of the absorbing solution in the reboiler,
the pressure of the regeneration tower is adjusted to a gauge pressure of 0.02 MPaG to 0.08 MPaG, and
the temperature control unit controls the heating temperature of the absorbing solution to be within a range of 87° C. to 100° C.

10. The carbon dioxide recovery device according to claim 9, wherein
the temperature control unit controls the heating temperature of the absorbing solution to be within a range of 90° C. to 97° C.

11. (canceled)

12. (canceled)

13. (canceled)

14. The carbon dioxide recovery device according to claim 9, further comprising
a stirrer that is provided in a reboiler to stir the absorbing solution stored in the reboiler.

15. The carbon dioxide recovery device according to claim 14, wherein
the stirrer is arranged at a position of a liquid surface of the absorbing solution to stir the absorbing solution.

16. The carbon dioxide recovery device according to claim 9, wherein
the reboiler includes an absorbing solution circulation system, and
the absorbing solution circulation system includes a branch pipe that extracts some of the absorbing solution stored in the reboiler and a shower nozzle that sprays the extracted absorbing solution into the reboiler again.

17. The carbon dioxide recovery device according to claim 9, further comprising
a heat exchanger that is interposed in an absorbing solution discharge pipe which connects an absorbing solution outlet of the absorption tower and an absorbing solution inlet of the regeneration tower and is interposed in an absorbing solution return pipe which connects an absorbing solution inlet of the absorption tower and an absorbing solution outlet of the regeneration tower to exchange heat of the absorbing solution in which the carbon dioxide is absorbed and the regenerated absorbing solution.

18. The carbon dioxide recovery device according to claim 17, further comprising
a heat exchanger that is provided in the absorbing solution return pipe between the absorbing solution inlet of the absorption tower and the heat exchanger to further cool the absorbing solution.
